(19) United States
(12) Patent Application Publication
(10) Pub. No.: US 2026/0313627 A1
(43) Pub. Date: Oct. 8, 2026

(54) CROSS LINK BEAM MANAGEMENT IN WLANS

(71) Applicant: Samsung Electronics Co., Ltd., Suwon-si (KR)

(72) Inventors: Peshal Nayak, Plano, TX (US); Bilal Sadiq, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US)

(21) Appl. No.: 19/575,674

(22) Filed: Mar. 23, 2026

Related U.S. Application Data
(60) Provisional application No. 63/785,478, filed on Apr. 8, 2025.
(60) Provisional application No. 63/878,614, filed on Sep. 9, 2025.
(60) Provisional application No. 63/976,664, filed on Feb. 5, 2026.

(51) Int. Cl. H04W 72/044; H04W 76/15

(52) U.S. Cl. CPC H04W 72/046; H04W 76/15

(57) ABSTRACT

Methods and apparatuses for supporting cross link beam management in WLANs. A method performed by an access point (AP) multi-link device (MLD) includes forming at least one link with a non-AP MLD for transmission of first information between the AP MLD and the non-AP MLD, wherein at least one of the at least one links is an anchor link, forming a millimeter wave (mmWave) link with the non-AP MLD for transmission of second information between the AP MLD and the non-AP MLD, and performing a beam training procedure with the non-AP MLD for selection of a beam to use for the transmission of the second information on the mmWave link.

### CROSS-REFERENCE TO RELATED APPLICATION(S) AND CLAIM OF PRIORITY

This application claims priority under 35 U.S.C. § 119(e) to U.S. Provisional Patent Application No. 63/785,478, filed on Apr. 8, 2025, U.S. Provisional Patent Application No. 63/878,614, filed on Sep. 9, 2025, and U.S. Provisional Patent Application No. 63/976,664, filed on Feb. 5, 2026. The above identified provisional patent applications are hereby incorporated by reference in their entirety.

### TECHNICAL FIELD

This disclosure relates generally to wireless communication, and more specifically to cross link beam management in wireless local area networks (WLANS).

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for supporting cross link beam management in WLANs.

In one embodiment, a method performed by an access point (AP) multi-link device (MLD) is provided. The method includes forming at least one link with a non-AP MLD for transmission of first information between the AP MLD and the non-AP MLD, wherein at least one of the at least one links is an anchor link, forming a millimeter wave (mmWave) link with the non-AP MLD for transmission of second information between the AP MLD and the non-AP MLD, and performing a beam training procedure with the non-AP MLD for selection of a beam to use for the transmission of the second information on the mmWave link.

In another embodiment, a method performed by a non-AP MLD includes forming at least one link with an AP MLD for transmission of first information between the non-AP MLD and the AP MLD, wherein at least one of the at least one links is an anchor link. The method includes forming a mmWave link with the AP MLD for transmission of second information between the non-AP MLD and the AP MLD. The method further includes performing a beam training procedure with the AP MLD for selection of a beam to use for the transmission of the second information on the mmWave link.

In yet another embodiment, an AP MLD includes at least one processor including processing circuitry, and memory storing instructions, where the instructions, when executed by the at least one processor individually or collectively, cause the AP MLD to form at least one link with a non-AP MLD for transmission of first information between the AP MLD and the non-AP MLD, wherein at least one of the at least one links is an anchor link. Further, the instructions, when executed by the at least one processor individually or collectively, cause the AP MLD to form a mmWave link with the non-AP MLD for transmission of second information between the AP MLD and the non-AP MLD. Further, the instructions, when executed by the at least one processor individually or collectively, cause the AP MLD to and perform a beam training procedure with the non-AP MLD for selection of a beam to use for the transmission of the second information on the mmWave link.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example of beamforming training according to embodiments of the present disclosure;

FIG. 4 illustrates another example of beamforming training according to embodiments of the present disclosure;

FIG. 5 illustrates an example method for beamforming training according to embodiments of the present disclosure; and

FIG. 6 illustrates an example method performed by an access point (AP) multi-link device (MILD) in a wireless communication system according to embodiments of the present disclosure.

### DETAILED DESCRIPTION

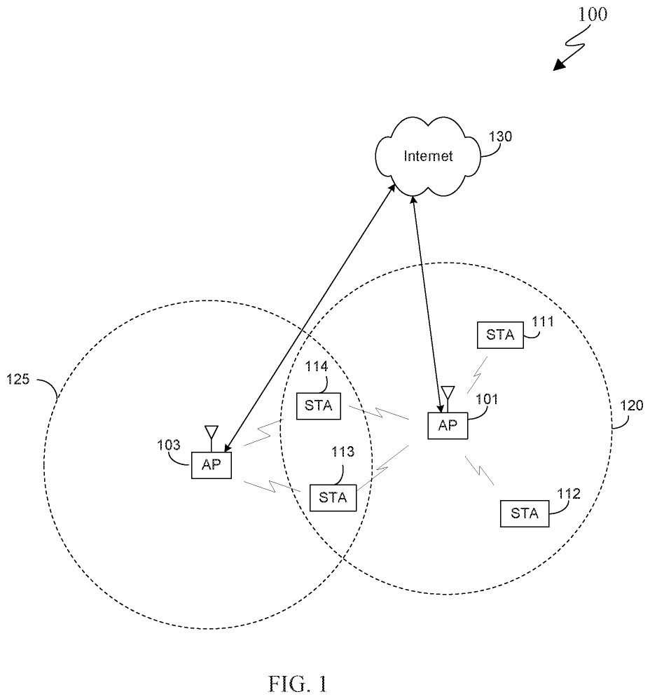

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D7.0, 2024.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for supporting cross link beam management in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

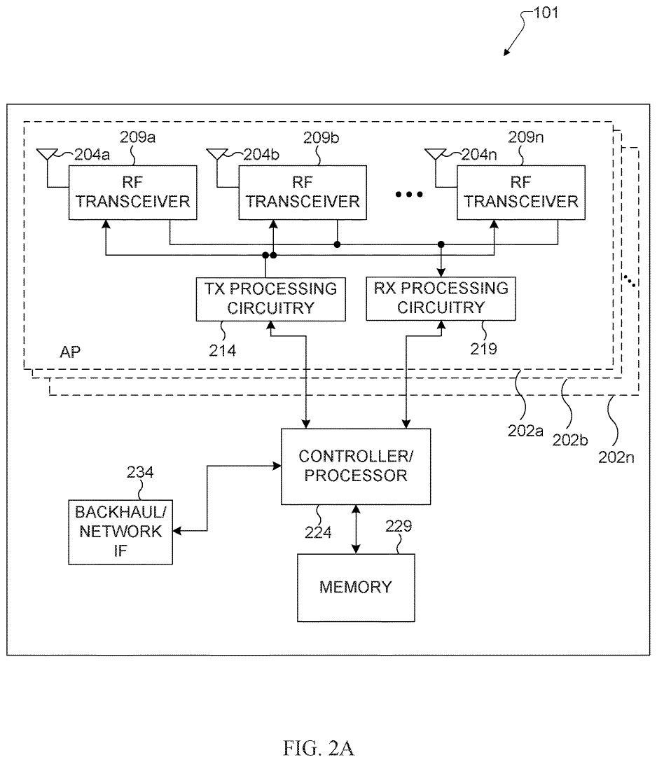

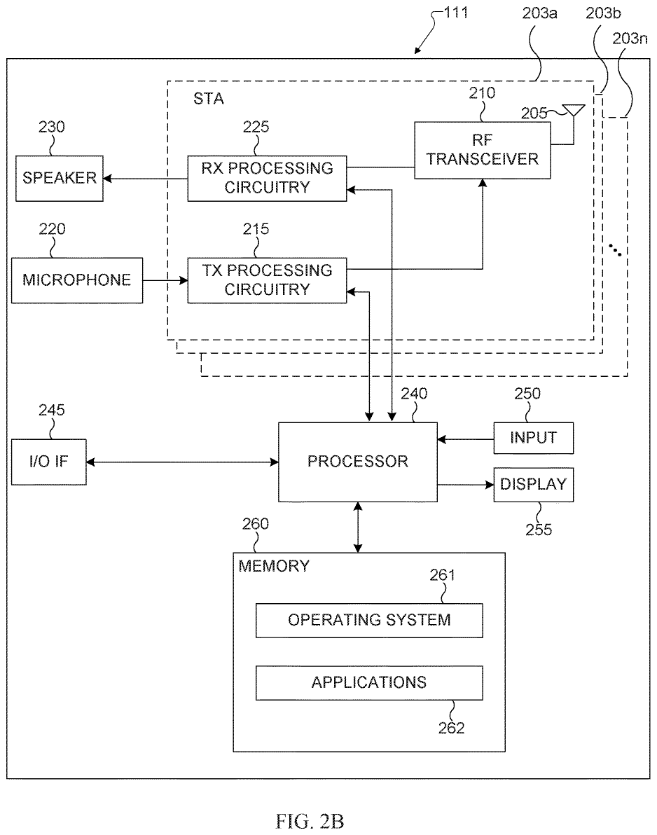

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including anchor link design for multi-link operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for cross link beam management in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to support cross link beam management in WLANs. In some embodiments, the processor 240 includes at least one microprocessor or microcontroller.

The processor 240 is also capable of executing other processes and programs resident in the memory 260, such as operations for supporting cross link beam management in WLANs. The processor 240 can move data into or out of the memory 260 as required by an executing process. In some embodiments, the processor 240 is configured to execute a plurality of applications 262, such as applications for supporting cross link beam management in WLANs. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Various embodiments of the present disclosure recognize that emerging applications such as XR, gaming, etc. often have a high throughput/stringent low latency requirement. mmWave band provides many opportunities for enhancing the performance of such applications. Typically, there is abundant spectrum available in the mmWave bands of operation. Further, the directional transmission also provides an opportunity for reducing interference and increasing spatial reuse. In the past, mmWave operation in Wi-Fi was driven by 802.11ad and any amendments. However, such designs propose independent architectures for mmWave operation. To minimize the complexity and cost while providing mmWave support, next generation WLANs can have an architecture in which a mmWave link can be integrated as an add-on to a multi-link device (MLD). Thus, mmWave can function as an additional link (in addition to existing sub-6 GHz/sub-7.25 GHz links) in MLDs.

Various embodiments of the present disclosure further recognize that in 802.11be, a new architecture was introduced based on multi-link operation (MLO). MLO operation defined a new architectural entity called MILD. An MLD can have one or more STAs affiliated with it. These STAs are called STAs affiliated with an MLD and they can be co-located on the same physical device. The affiliated STAs can either be AP STAs or non-AP STAs. Information on each affiliated AP STAs can be advertised by an AP MLD in management frames such as beacons, probe responses, etc. transmitted by these affiliated AP STAs.

Various embodiments of the present disclosure recognize that when a non-AP MLD is associated with an AP MILD, the non-AP MLD can have one or more STAs affiliated with it. In the same manner, the AP MLD can have one or more APs affiliated with it. The non-AP MLD can have multiple links setup with the AP MILD. One or more of those setup links can be in a sub-7.25 GHz band. Further, one or more of those setup links can also be in a mmWave band. A link setup between the non-AP MLD and the AP MLD in a mmWave band can operate in a non-standalone manner—i.e., the AP on the mmWave link may not operate independently. Rather, it can make use of the one or more links setup in the sub-7.25 GHz band to support the operation of the mmWave link. As a result, the mmWave link AP can stop performing certain operations (e.g., beaconing on the mmWave link) and offload the corresponding frames and procedures to the sub-7.25 GHz band. Additionally, the mmWave link can operate based on assistance from an anchor link. The anchor link can assist the operation of the mmWave link. An anchor link can be any link in the sub-7.25 GHz band. In a default configuration, all the links in the sub 7.25 GHz band can act as anchor links for the mmWave link. Alternatively, a subset of the sub-7.25 GHz band links can be used as anchor links.

Due to the directional nature of the mmWave, beam training is necessary for proper selection and usage of the right beam. In non-standalone (NSA) mode of operation, cross link beam management can be employed by leveraging support from the sub-7.25 GHz links. In non-standalone mmWave operation, a cross link beam management procedure is needed.

Accordingly, the present disclosure provides a number of solutions for handling cross link beam management. Aspects include:
1. Announcement/setup of beam training on anchor link
2. Transmission/reception and measurement of reference signal on mmWave link
3. Pulling/triggering beam training measurement report on anchor link
4. Confirmation of a successful pull
5. Examples
6. Capability advertisement.

In some embodiments, there can be an announcement/setup message that can be transmitted on an anchor link. The announcement/setup message can contain at least one or more of the information items as shown in Table 1.

TABLE 1
Information content of announcement/setup message

| Information | |
|---|---|
| content | Description |
| Non-AP MLD | One or more information items that can identify the |
| identifier | non-AP MLDs that can participate in the beam training |
| | procedure. For example, non-AP MLD MAC address, |
| | AIDs, etc. |
| Start time of the | One or more information items that can identify the |
| beam training | start time of the beam training procedure. For example, |
| procedure | start time relative to the TSF time of the anchor link. |
| Duration | One or more information items that can identify the |
| | duration of the beam training procedure. For example, |
| | duration in terms of TUs. |

An example of an announcement/setup message can be a null data packet announcement (NDPA) message.

In some embodiments, a reference signal can be transmitted on the mmWave link. The receiver of the reference signal can use the reference signal to perform measurements.

According to another embodiment, a reference signal can be transmitted on the sub-7 GHz link (e.g., an anchor link).

An example of a reference signal can be a null data packet (NDP) frame.

Moreover, there can also be a beam sweep on the mmWave (e.g., using NDP or another frame) without the associated NDPA. For example, beam sweep may be pre-configured. For example, beam sweep may be periodic or semi-persistent. A measurement done on this beam sweep may be reported on the sub-7 link.

In some embodiments, the beam training measurement report can be pulled from the anchor link. Either it can be transmitted by using enhanced distributed channel access (EDCA) or the report can be triggered.

In some embodiments, there can be a confirmation message transmitted as a confirmation of a successful pull.

In the embodiments discussed below, the sub-7 GHz link can be an anchor link.

In some embodiments, for an integrated millimeter wave (IMMW) solution for IEEE 802.11bq, the beamforming training process can be optimized by leveraging the multi-link operation (MLO) framework. In this setup, the sub-7 GHz link is used for transmitting control and feedback information, such as channel state information (CSI), beamforming matrix indices, and acknowledgement packets. Meanwhile, the actual beam training process, including sounding packet transmission and beam refinement, occurs on the millimeter wave (mmWave) link. This separation allows the mmWave link to focus on high-speed beam alignment without being bogged down by control overhead, while the sub-7 GHz link ensures reliable delivery of critical feedback information.

In some embodiments, the IMMW solution can incorporate dynamic link selection for beamforming training. For instance, if the sub-7 GHz link experiences congestion or poor channel conditions, the system can dynamically switch the control and feedback information to another available sub-7 GHz link or even a low-latency mmWave link with a dedicated control channel. This ensures that beamforming training proceeds uninterrupted, even in challenging environments. The dynamic selection can be based on metrics such as link throughput, latency, and signal-to-noise ratio (SNR), ensuring optimal performance.

In some embodiments, the IMMW solution can employ interference mitigation techniques during beamforming training. For example, when multiple devices are performing beamforming training simultaneously, the system can use time-division multiplexing or frequency hopping on the mmWave link to minimize interference. Additionally, the sub-7 GHz link can be used to coordinate beamforming training schedules among devices, ensuring that concurrent training sessions do not overlap in time or frequency. This coordinated approach significantly reduces interference and improves the accuracy of beam alignment.

In some embodiments, the IMMW solution can utilize joint feedback mechanisms for beamforming training. For instance, both the sub-7 GHz and mmWave links can provide complementary feedback information, such as CSI for different frequency bands, to enable more accurate beamforming at the mmWave link. The feedback from the sub-7 GHz link can be used to guide initial beam selection, while the mmWave link refines the beams based on its own CSI. This joint feedback mechanism enhances the overall beamforming accuracy and system performance.

In some embodiments, the IMMW solution can implement adaptive beamforming training periods. For example, the duration of beamforming training on the mmWave link can be dynamically adjusted based on the observed channel conditions. If the channel is stable, shorter training periods can be used to reduce overhead. Conversely, in dynamic or fading channels, longer training periods ensure robust beam alignment. The sub-7 GHz link can be used to communicate these adjustments, allowing seamless adaptation without disrupting ongoing data transmission.

In some embodiments, the IMMW solution can integrate multi-user beamforming training. For instance, multiple users can perform beamforming training simultaneously on the mmWave link, while the sub-7 GHz link coordinates their training schedules and feedback transmissions. This approach increases system capacity by enabling parallel beamforming training sessions. Additionally, advanced scheduling algorithms can prioritize users based on their quality of service (QoS) requirements, ensuring efficient resource utilization.

In some embodiments, the IMMW solution can incorporate energy-efficient beamforming training. For example, low-power devices can leverage the sub-7 GHz link for initial beamforming training, reserving the mmWave link for final beam refinement. This reduces power consumption by minimizing the use of high-power mmWave transmitters during the initial stages of beamforming. Furthermore, the system can employ wake-up signals over the sub-7 GHz link to activate mmWave transceivers only when necessary, further conserving energy.

In some embodiments, the IMMW solution can utilize machine learning-based beamforming training optimization. For instance, historical data from both the sub-7 GHz and mmWave links can be used to train predictive models that anticipate optimal beam configurations based on environmental factors like user movement or interference patterns. These predictions can then be transmitted over the sub-7 GHz link, enabling proactive beam adjustments on the mmWave link without requiring extensive real-time training. This approach reduces latency and improves system responsiveness in dynamic environments.

In some embodiments, the IMMW solution can support seamless handover during beamforming training. For example, if a user moves out of range of the current access point (AP), the system can initiate handover to another AP while maintaining ongoing beamforming training on the mmWave link. The sub-7 GHz link can be used to negotiate handover parameters and ensure uninterrupted service. This seamless handover capability is particularly critical for applications requiring high mobility, such as augmented reality or virtual reality.

In one embodiment, the entire procedure can be performed on the mmWave link as described herein. This may be useful when the channel access delay of the sub-7 link/anchor link is high, or when the AP prefers to minimize overhead on sub-7 GHz, e.g., due to already high utilization.

The procedure can be performed on the mmWave link as follows: the mmWave AP sends the NDPA, the mmWave AP sends the NDP, the mmWave non-AP STA performs measurement, the mmWave AP pulls the report from the mmWave non-AP STA at a later point in time and the mmWave non-AP STA transmits the report. The frame transmitted to pull the report from the mmWave non-AP STA may incur a separate channel access delay on the mmWave and may not be separated by a SIFS gap from the NDP. The mmWave non-AP STA may also transmit the report on its own without a pull or request from the mmWave AP.

In one embodiment, the procedure can be performed as follows: the Sub-7 GHz link AP (affiliated with the AP MLD) transmits the NDPA, the mmWave link AP (affiliated with the same AP MLD) sends the NDP, the mmWave non-AP STA (affiliated with the non-AP MLD) performs measurement, the Sub-7 GHz AP pulls the report through the sub-7 GHz non-AP STA.

The non-AP MLD may also transmit the report on its own without a pull or request from an AP. The non-AP MLD may transmit the report on a sub-7 GHz non-AP STA even though the report contains a measurement performed on the mmWave link. The report therefore may contain an indication of the link on which an associated measurement was performed.

When reporting on a different link than the one on which the measurement was performed, the non-AP STA may send a measurement report while the reference signal transmission on the mmWave is still ongoing or has not yet completed. For example, when the mmWave AP is beam sweeping a reference signal, e.g., using NDP or BFT frames, and the mmWave non-AP STA through measurement discovers a beam with adequate quality, the non-AP MLD may send a report on a sub-7 GHz link before the reference signal transmission has completed. Whether a measured beam has adequate quality may be determined based on a criteria configured by the AP, e.g., a beam RSRP having a higher value than an RSRP threshold provided by the AP. Such a report from the non-AP STA may indicate that it is being sent based on partial measurement.

The reporting sub-7 GHz link may be restricted to be the same sub-7 GHz link on which the NDPA was sent.

The sub-7 GHz link can be an anchor link.

In one embodiment, the procedure can be performed as follows: the Sub-7 GHz link AP (affiliated with the AP MLD) transmits the NDPA, the mmWave link AP (affiliated with the same AP MLD) sends the NDP, the mmWave non-AP STA (affiliated with the non-AP MLD) performs measurement, the Sub-7 GHz AP pulls the report from the sub-7 GHz non-AP STA.

The non-AP MLD may also transmit the report on its own without a pull or request from an AP. Non-AP MLD may transmit the report on a Sub7 GHz non-AP STA even though the report contains a measurement performed on the mmWave link. The report therefore may contain an indication of the link on which an associated measurement was performed.

The reporting sub-7 GHz link can be different from the sub-7 GHz link on which the NDPA was sent.

In one embodiment, the procedure can be performed as follows: the mmWave link AP (affiliated with the AP MILD) transmits the NDPA, the mmWave link AP sends the NDP, the mmWave non-AP STA (affiliated with the non-AP MLD) performs measurement, the Sub-7 GHz AP pulls the report from the sub-7 GHz non-AP STA (affiliated with the same non-AP MLD).

The non-AP MLD may also transmit the report on its own without a pull or request from an AP. Non-AP MLD may transmit the report on a Sub7 GHz non-AP STA even though the report contains a measurement performed on the mmWave link. The report therefore may contain an indication of the link on which an associated measurement was performed.

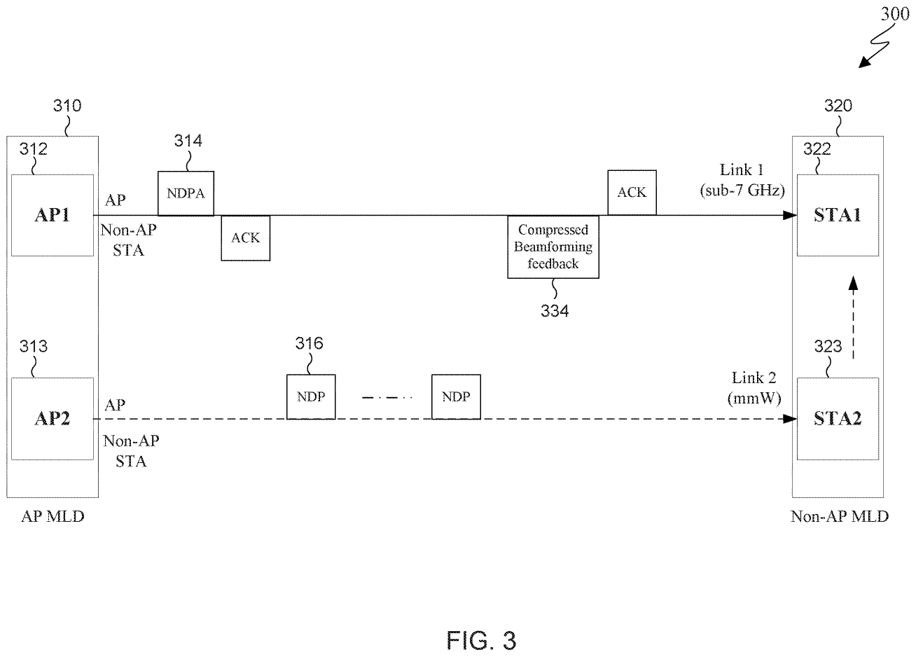

FIG. 3 illustrates an example of beamforming training 300 according to embodiments of the present disclosure. The beamforming training 300 of FIG. 3 can be performed by any of the STAs 111-114 of FIG. 1, such as the STA 111 of FIG. 2B, and any of the APs 101-103 of FIG. 1, such as AP 101 of FIG. 2A. The beamforming training 300 is for illustration only and other embodiments can be used without departing from the scope of the present disclosure.

As illustrated in FIG. 3, according to one embodiment, for an integrated millimeter wave (IMMW) solution for IEEE 802.11bq, the access point AP1 312 affiliated with the AP MLD 310 initiates beamforming training by transmitting a null data packet announcement (NDPA) 314 on the sub-7 GHz link. The NDPA 314 serves as a trigger for non-AP stations (STAs) 322, 323 associated with non-AP MLD 320 to prepare for beamforming training on the mmWave link. The AP2 313 associated with the AP MLD 310 then transmits a Null Data Packet (NDP) 316 on the mmWave link, which contains no data but is used by the STA2 323 to perform channel estimation. The STA2 323 receives this NDP 316 on its chosen analog beam and uses it to estimate the channel characteristics between itself and the AP2 313.

According to one example, the STA2 323 processes the received mmWave NDP 316 to prepare compressed Channel State Information (CSI) feedback. This compression is used to reduce overhead on the sub-7 GHz link, which is used for transmitting the Beamforming Report (BF report) 334. The CSI feedback includes information such as the preferred beam indices and channel quality metrics, which are derived from the channel estimation performed using the mmWave NDP. The compressed BF report 334 is then transmitted back to the AP1 312 over the sub-7 GHz link, ensuring efficient use of resources.

According to one example, the IMMW solution can enhance the accuracy of channel estimation by incorporating multiple NDP transmissions on the mmWave link. For example, the AP can send multiple NDPs with different beam configurations, allowing the non-AP STA to evaluate and select the optimal beam pair that maximizes throughput. The non-AP STA then compresses the CSI feedback for each evaluated beam configuration and transmits the most favorable one over the sub-7 GHz link. This approach ensures that the AP has sufficient information to make informed beamforming decisions.

As shown in FIG. 3, in the example beamforming training in IMMW, NDPA is used as the beamforming trigger frame and NDP is used as the beamform training frame, and compressed beamforming feedback is used as the beamforming report.

In some embodiments, STA1 322 can be a STA affiliated with AP MLD 310.

In some embodiments, STA1 322 can be a STA affiliated with non-AP MLD 320.

In some embodiments, STA2 323 can be a STA affiliated with AP MLD 310.

In some embodiments, STA2 323 can be a STA affiliated with non-AP MLD 320.

In some embodiments, the gap between the announcement/setup message and the reference signal can be a short interframe space (SIFS) duration.

In some embodiments, the gap between the announcement/setup message and the reference signal can be different than SIFS. For example, a channel access delay.

In some embodiments, the transmission of the reference signal can need an independent channel access.

In some embodiments, the triggering or pulling of the measurement report can need an independent channel access.

In some embodiments, the anchor link used for the above operation can be the same for all the non-AP MLDs in the announcement/setup message.

In some embodiments, the anchor link used for the above operation can be different for different non-AP MLDs in the announcement/setup message.

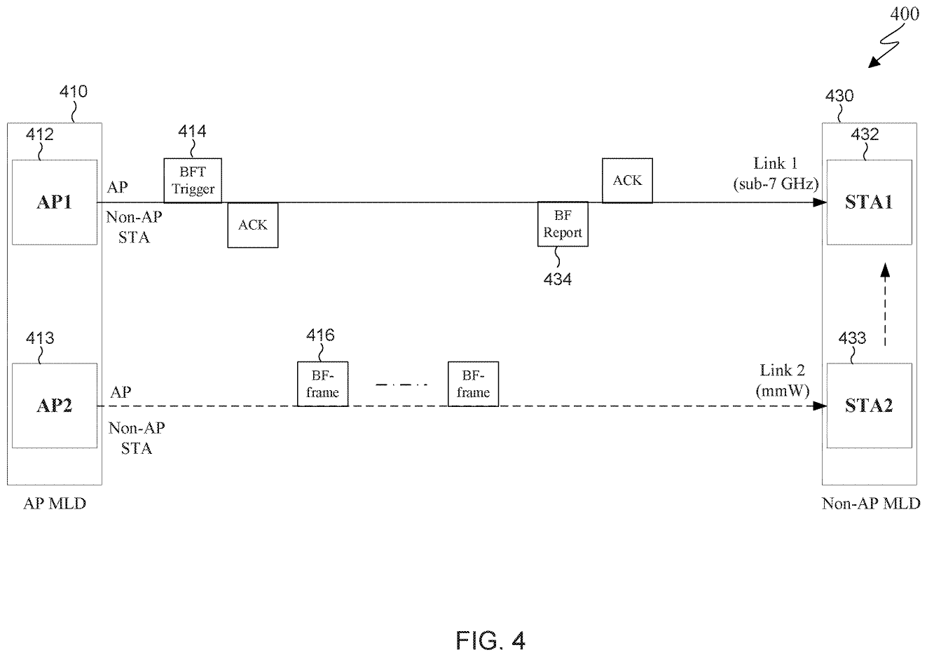

FIG. 4 illustrates another example of beamforming training 400 according to embodiments of the present disclosure. The beamforming training 400 of FIG. 4 can be performed by any of the STAs 111-114 of FIG. 1, such as the STA 111 of FIG. 2B, and any of the APs 101-103 of FIG. 1, such as AP 101 of FIG. 2A. The beamforming training 400 is for illustration only and other embodiments can be used without departing from the scope of the present disclosure.

As illustrated in FIG. 4, according to one embodiment, for an integrated millimeter wave (IMMW) solution for IEEE 802.11bq, the access point AP1 412 affiliated with the AP MLD 410 initiates beamforming training by transmitting a beamforming (BF) trigger 414 on the sub-7 GHz link. The BF trigger 414 serves as a trigger for non-AP stations (STAs) 422, 423 associated with non-AP MLD 420 to prepare for beamforming training on the mmWave link. The AP2 413 associated with the AP MLD 410 then transmits a BF frame 416 on the mmWave link, which contains no data but is used by the STA2 423 to perform channel estimation. The STA2 423 receives this BF frame 416 on its chosen analog beam and uses it to estimate the channel characteristics between itself and the AP2 413.

In some embodiments, the STA2 423 processes the received mmWave BF frame 416 to transmit the BF report) 434 on the sub-7 GHz link. The BF report 434 is then transmitted back to the AP1 412 over the sub-7 GHz link, ensuring efficient use of resources.

In some embodiments, the IMMW solution can enhance the accuracy of channel estimation by incorporating multiple BF frame transmissions on the mmWave link. For example, the AP can send multiple BF frames with different beam configurations, allowing the non-AP STA to evaluate and select the optimal beam pair that maximizes throughput. The non-AP STA then transmits the most favorable evaluated beam configuration over the sub-7 GHz link. This approach ensures that the AP has sufficient information to make informed beamforming decisions.

In one embodiment, the beamforming training procedure can be performed as follows: The mmWave AP transmits an NDP frame. There is no explicit announcement frame for the NDP frame but the transmission time is known to the mmWave STA ahead of time (e.g., via frame exchanges on an anchor link). The mmWave non-AP STA performs measurement. The Sub-7.25 GHz AP pulls the report from the sub-7.25 GHz non-AP STA. Alternatively, the non-AP MLD may also transmit the report on its own without a pull or request from an AP. The non-AP MLD may transmit the report on a sub-7 GHz non-AP STA even though the report contains a measurement performed on the mmWave link. The report therefore may contain an indication of the link on which an associated measurement was performed.

In one embodiment, the IMMW solution can employ predictive algorithms to optimize compressed CSI feedback. For instance, the non-AP STA can use historical data from previous channel estimates to predict future channel conditions and adjust the compression of CSI feedback accordingly. This prediction allows the STA to prioritize critical information in the BF report while minimizing redundant data transmission over the sub-7 GHz link. The AP, in turn, uses these predictions to adapt its beamforming strategy proactively.

In one embodiment, the IMMW solution can leverage machine learning techniques to enhance beam selection based on compressed CSI feedback. For example, the AP and non-AP STA can collaborate by sharing historical data about beam performance under various environmental conditions. Machine learning models trained on this data can predict the most suitable beams for future transmissions, enabling the system to switch seamlessly between optimal beam configurations without extensive real-time training. The compressed BF reports are then used to refine these predictions further.

In one embodiment, the IMMW solution can implement dynamic beam switching during the beamforming training process. For instance, if a non-AP STA detects significant movement or changes in its surroundings that affect channel conditions, it can dynamically switch its analog beam configuration and retransmit compressed CSI feedback over the sub-7 GHz link. The AP receives this updated feedback and adjusts its beamforming parameters accordingly to maintain optimal communication. This dynamic adaptation ensures robust performance even in highly mobile environments.

In one embodiment, the IMMW solution can incorporate energy-efficient beamforming training. For example, low-power devices can leverage the sub-7 GHz link for initial beamforming training, reserving the mmWave link for final beam refinement. This reduces power consumption by minimizing the use of high-power mmWave transmitters during the initial stages of beamforming. Furthermore, the system can employ wake-up signals over the sub-7 GHz link to activate mmWave transceivers only when necessary, further conserving energy.

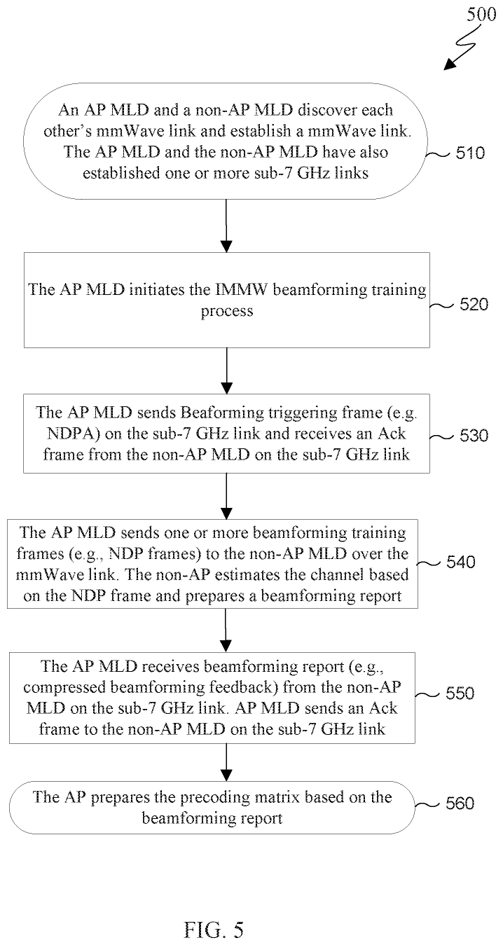

FIG. 5 illustrates an example method 500 for beamforming training according to embodiments of the present disclosure. The method 500 for beamforming training of FIG. 5 can be performed by any of the APs 101-103 of FIG. 1, such as AP 101 of FIG. 2A, and a corresponding method can be performed by any of the STAs 111-114 of FIG. 1, such as the STA 111 of FIG. 2B. The embodiment of the method 500 for beamforming training of FIG. 5 is for illustration only. Different embodiments of the method 500 for beamforming training could be used without departing from the scope of this disclosure.

As shown in FIG. 5, the method 500 begins at step 510, where an AP MLD, such as AP MLD 310 of FIG. 3, and a non-AP MLD, such as non-AP MLD 320 of FIG. 3, discover each other's mmWave link and establish a mmWave link. The AP MLD and the non-AP MLD have also established one or more sub-7 GHz links. At step 520, the AP MLD initiates the IMMW beamforming training process. At step 530, the AP MLD sends a beamforming triggering frame (e.g., NDPA) on the sub-7 GHz link and receives an Ack frame from the non-AP MLD on the sub-7 GHz link. At step 540, the AP MLD sends one or more beamforming training frames (e.g., NDP frames) to the non-AP MLD over the mmWave link. The non-AP estimates the channel based on the NDP frame and prepares a beamforming report. At step 550, the AP MLD receives the beamforming report (e.g., compressed beamforming feedback) from the non-AP MLD on the sub-7 GHz link. The AP MLD sends an Ack frame to the non-AP MLD on the sub-7 GHz link. At step 560, the AP MLD prepares the precoding matrix based on the beamforming report.

In some embodiments, an AP MLD that can have the capabilities for procedures in this disclosure can advertise the capability in one or more frames that it can transmit. For example, beacons, probe responses, etc.

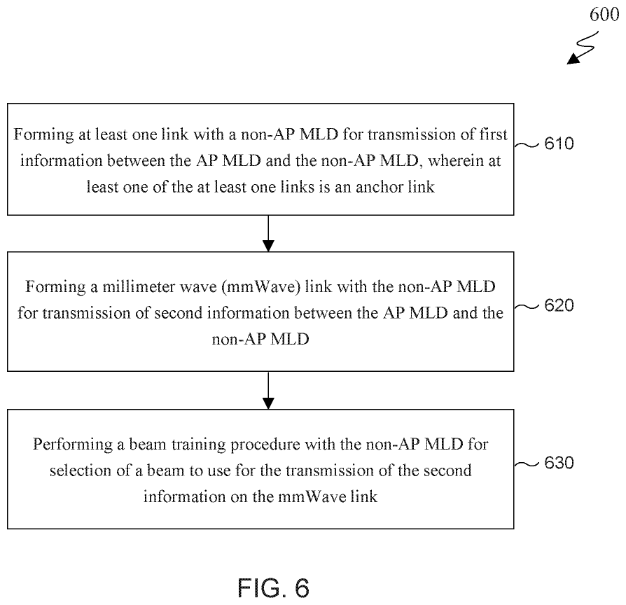

FIG. 6 illustrates an example method 600 performed by an access point (AP) multi-link device (MLD) in a wireless communication system according to embodiments of the present disclosure. The method 600 of FIG. 6 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 600 is for illustration only and other embodiments can be used without departing from the scope of the present disclosure.

As illustrated in FIG. 6, the method 600 begins at step 610, where the AP MLD forms at least one link with a non-AP MLD for transmission of first information between the AP MLD and the non-AP MLD, wherein at least one of the at least one links is an anchor link. At step 620, the AP MLD forms a millimeter wave (mmWave) link with the non-AP MLD for transmission of second information between the AP MLD and the non-AP MLD. At step 630, the AP MLD performs a beam training procedure with the non-AP MLD for selection of a beam to use for the transmission of the second information on the mmWave link.

In some embodiments, the AP MLD transmits, to the non-AP MLD on the anchor link, a message for setting up the beam training procedure.

In some embodiments, the message for setting up the beam training procedure includes information indicating at least one of non-AP MLDs that can participate in the beam training procedure, a start time of the beam training procedure, and a duration of the beam training procedure.

In some embodiments, the AP MLD transmits, to the non-AP MLD on the mmWave link, a reference signal for performing measurements, and receives, from the non-AP MLD on the anchor link, a beam training measurement report based on the measurements.

In some embodiments, the AP MLD transmits, to the non-AP MLD, a first message confirming a successful pull of the beam training measurement report on the anchor link by the AP MLD.

In some embodiments, the AP MLD transmits, to the non-AP MLD on the anchor link, a trigger to fetch the beam training measurement report; or receives the beam training measurement report based on an enhanced distributed channel access (EDCA) mechanism.

In some embodiments, the AP MLD transmits, to the non-AP MLD on the mmWave link, a message for setting up the beam training procedure.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by an access point (AP) multi-link device (MLD), the method comprising:
forming at least one link with a non-AP MLD for transmission of first information between the AP MLD and the non-AP MLD, wherein at least one of the at least one links is an anchor link;
forming a millimeter wave (mmWave) link with the non-AP MLD for transmission of second information between the AP MLD and the non-AP MLD; and
performing a beam training procedure with the non-AP MLD for selection of a beam to use for the transmission of the second information on the mmWave link.

2. The method of claim 1, wherein performing the beam training procedure comprises transmitting, to the non-AP MLD on the anchor link, a message for setting up the beam training procedure.

3. The method of claim 2, wherein the message for setting up the beam training procedure includes information indicating at least one of non-AP MLDs that can participate in the beam training procedure, a start time of the beam training procedure, and a duration of the beam training procedure.

4. The method of claim 1, wherein performing the beam training procedure comprises:
transmitting, to the non-AP MLD on the mmWave link, a reference signal for performing measurements; and
receiving, from the non-AP MLD on the anchor link, a beam training measurement report based on the measurements.

5. The method of claim 4, further comprising transmitting, to the non-AP MLD, a first message confirming a successful pull of the beam training measurement report on the anchor link by the AP MLD.

6. The method of claim 4, further comprising:
transmitting, to the non-AP MLD on the anchor link, a trigger to fetch the beam training measurement report; or
receiving the beam training measurement report based on an enhanced distributed channel access (EDCA) mechanism.

7. The method of claim 1, wherein performing the beam training procedure comprises transmitting, to the non-AP MLD on the mmWave link, a message for setting up the beam training procedure.

8. A method performed by a non-access point (AP) multi-link device (MILD), the method comprising:
forming at least one link with an AP MILD for transmission of first information between the non-AP MLD and the AP MLD, wherein at least one of the at least one links is an anchor link;
forming a millimeter wave (mmWave) link with the AP MLD for transmission of second information between the non-AP MLD and the AP MLD; and
performing a beam training procedure with the AP MLD for selection of a beam to use for the transmission of the second information on the mmWave link.

9. The method of claim 8, wherein performing the beam training procedure comprises receiving, from the AP MLD on the anchor link, a message for setting up the beam training procedure.

10. The method of claim 9, wherein the message for setting up the beam training procedure includes information indicating at least one of non-AP MLDs that can participate in the beam training procedure, a start time of the beam training procedure, and a duration of the beam training procedure.

11. The method of claim 8, wherein performing the beam training procedure comprises:
receiving, from the AP MLD on the mmWave link, a reference signal for performing measurements; and
transmitting, to the AP MLD on the anchor link, a beam training measurement report based on the measurements.

12. The method of claim 11, further comprising receiving, from the AP MLD, a first message confirming a successful pull of the beam training measurement report on the anchor link by the AP MLD.

13. The method of claim 11, further comprising
receiving, from the AP MLD on the anchor link, a trigger to fetch the beam training measurement report; or
transmitting the beam training measurement report based on an enhanced distributed channel access (EDCA) mechanism.

14. The method of claim 8, wherein performing the beam training procedure comprises transmitting, to the non-AP MLD on the mmWave link, a message for setting up the beam training procedure.

15. An access point (AP) multi-link device (MLD) comprising:
at least one processor including processing circuitry; and
memory storing instructions, wherein the instructions, when executed by the at least one processor individually or collectively, cause the AP MLD to:
form at least one link with a non-AP MLD for transmission of first information between the AP MLD and the non-AP MILD, wherein at least one of the at least one links is an anchor link;
form a millimeter wave (mmWave) link with the non-AP MLD for transmission of second information between the AP MLD and the non-AP MLD; and
perform a beam training procedure with the non-AP MLD for selection of a beam to use for the transmission of the second information on the mmWave link.

16. The method of claim 15, wherein to perform the beam training procedure, the instructions, when executed by the at least one processor individually or collectively, cause the AP MLD to transmit, to the non-AP MLD on the anchor link, a message for setting up the beam training procedure.

17. The method of claim 16, wherein the message for setting up the beam training procedure includes information indicating at least one of non-AP MLDs that can participate in the beam training procedure, a start time of the beam training procedure, and a duration of the beam training procedure.

18. The method of claim 15, wherein to perform the beam training procedure, the instructions, when executed by the at least one processor individually or collectively, cause the AP MLD to:
transmit, to the non-AP MLD on the mmWave link, a reference signal for performing measurements; and
receive, from the non-AP MLD on the anchor link, a beam training measurement report based on the measurements.

19. The method of claim 18, wherein the instructions, when executed by the at least one processor individually or collectively, cause the AP MLD to transmit, to the non-AP MILD, a first message confirming a successful pull of the beam training measurement report on the anchor link by the AP MLD.

20. The method of claim 18, wherein the instructions, when executed by the at least one processor individually or collectively, cause the AP MLD to:
transmit, to the non-AP MLD on the anchor link, a trigger to fetch the beam training measurement report; or
receive the beam training measurement report based on an enhanced distributed channel access (EDCA) mechanism.
